(19) United States
(12) Patent Application Publication
(10) Pub. No.: US 2005/0105989 A1
(43) Pub. Date: May 19, 2005

(54) Rotary punch and punch pin holder

(75) Inventor: Phillip Crudo, Round Lake, IL (US)

Correspondence Address: LEYDIG VOIT & MAYER, LTD, TWO PRUDENTIAL PLAZA, SUITE 4900, 180 NORTH STETSON AVENUE, CHICAGO, IL, 60601-6780, US

(73) Assignee: General Binding Corporation, Northbrook, IL (US)

(21) Appl. No.: 10/982,089

(22) Filed: Nov. 4, 2004

Related U.S. Application Data
(63) Continuation of application No. PCT/US03/13983, filed on May 5, 2003.
(60) Provisional application No. 60/378,334, filed on May 6, 2002.

(51) Int. Cl. B42B 5/08

(52) U.S. Cl. 412/38

(57) ABSTRACT

The invention provides a rotary punch assembly for punching successive sheets of paper, the assembly comprising a first punch pin roller and a second roller which form a nip therebetween. The first punch pin roller has a plurality of punch pins protruding therefrom and is driven, while the second roller has a resilient surface and is freely rotating. As a sheet is passed through the nip between the rollers, the punch pins penetrate the paper as the pins work against the resilient surface of the second roller to pierce the holes.

### CROSS REFERENCE TO RELATED PATENT APPLICATIONS

This application is a continuation of International Patent Application No. PCT/US03/13983, filed May 5, 2003, which claims priority to U.S. Provisional Patent Application No. 60/378,334, filed May 6, 2002.

### FIELD OF THE INVENTION

The invention relates generally to automated punching machines for perforating one or more sheets. More particularly, the invention relates to rotary punches typically utilized in in-line processing.

### BACKGROUND OF THE INVENTION

In the paper finishing industry, automatic die punching machines are utilized to punch regular, repeating patterns of holes through individual sheets or stacks of sheets in preparation for binding. Typical die punching machines utilize either reciprocating die punches which are actuated by a ram, or rotary die punches. In rotary die punches, one or more sheets are passed between a punch pin roller from which a plurality of punch pins protrude and a die roller having precision openings for receiving the punch pins. Such traditional rotary punches have complex gearing structures because the pins and the dies must precisely mate. As a result, changing or trading-out the pins or dies is generally an expensive and involved undertaking, typically resulting in a considerable amount of down time for the punch.

### OBJECTS AND SUMMARY OF THE INVENTION

It is a primary object to provide a rotary punch that is reliable, and economical to produce and operate.

Another object of the invention is to provide a simplified rotary punch that includes a minimal number of moving parts and that is less complex than those currently available in the market.

A further object is to provide a rotary punch that is compact in design.

An additional object is to provide a rotary punch arrangement that has reduced service costs and wherein the individual components may be relatively easily and quickly changed out.

In accordance with these and other objects of the invention, there is provided a rotary punch which includes a driven cylindrical punch pin roller and a freely rotating base roller which includes a relatively soft, resilient surface. As a sheet of paper is passed between the driven punch pin roller and the freely rotating resilient base roller, the punch pins penetrate the paper as the pins work against the resilient surface of the base roller to pierce holes into the paper.

Thus, the inventive punch design utilizing a single driven roller and a freely rotating second roller provides a much simplified design over the current rotary punches which typically include very complex gearing arrangements in order to accurately drive the lower die roller in time with the upper punch pin roller. As a result, the complexity and associated cost of servicing the inventive new punch will also be greatly reduced over conventional designs. This reduced complexity is particularly apparent in the elimination of the complex gearing arrangements required in traditional rotary punches to accurately drive and synchronize the lower die roller for proper engagement with the upper punch pin roller. Consequently, the components of the inventive punch arrangement may be singularly quickly replaced or modified, i.e., the lower roller, the punch pin roller, or the punch pins themselves may be readily changed out. In sharp contrast, a traditional punch pin roller or die roller would require the complete punch assembly to be removed and disassembled in order to change out any single component. The rapid changeover of the inventive new punch design also allows for quickly changing the punch design itself, i.e., the hole arrangement, shape, number, and size.

These and other advantages of the invention, as well as additional inventive features, will be apparent from the description of the invention provided herein.

### BRIEF DESCRIPTION OF THE DRAWINGS

FIG. 1 is a perspective view of a rotary punch arrangement constructed in accordance with teachings of the invention.

FIG. 2 is a perspective view of a further embodiment of a rotary punch arrangement constructed in accordance with teachings of the invention.

### DETAILED DESCRIPTION OF THE PREFERRED EMBODIMENTS

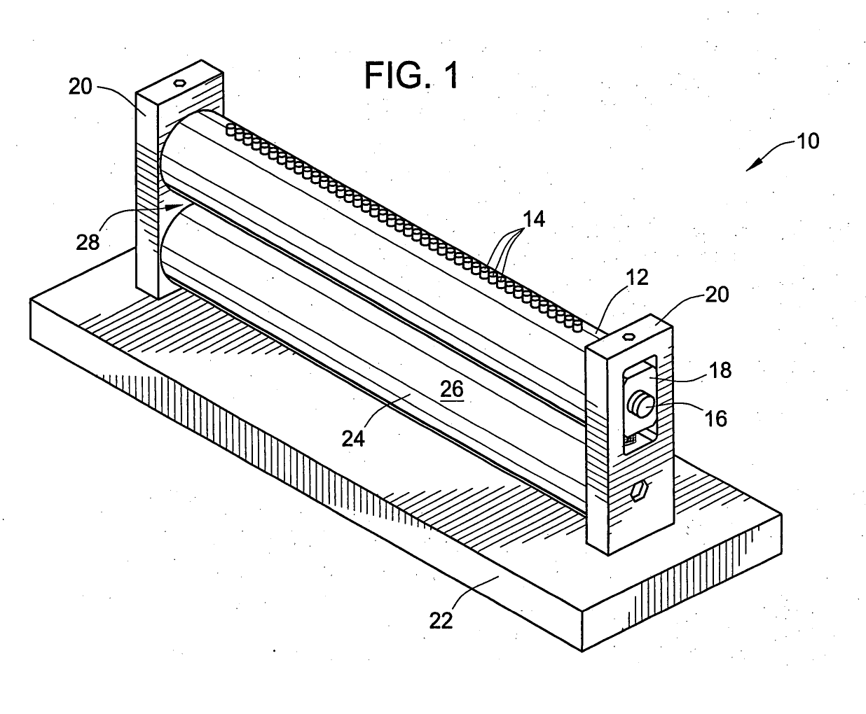

Turning now to the drawing, there is shown in FIG. 1 a rotary punch arrangement constructed in accordance with teachings of the invention. The rotary punch assembly 10 includes a cylindrical punch pin roller or pin holder 12 from which a plurality of punch pins 14 extend. Although shown in a round configuration, the punch pins 14 may be of substantially any shape, size, number, and distribution along the roller 12. Further, while a single row of punch pins 14 is illustrated such that a single row of perforations is made in a single sheet during each rotation of the punch pin roller 12, it is understood that multiple rows of punch pins 14 may alternately be provided.

The punch pin roller 12 is secured to a shaft 16 that is journalled for rotation in bearing supports 18. Although the bearing supports 18 are supported in a pair of roller supports 20 secured to a base 22 or other frame, it will be appreciated by those of skill in the art that the rotary punch assembly 10 will be assembled into or secured to a punch machine or an in-line printer or the like to punch a series of sheets progressing down a line. While not shown, it will further be appreciated that the sheets to be punched may be fed to the rotary punch assembly by any appropriate means, such as, for example, a plurality of rollers and/or belts or the like. Examples of such punch stations or machines in which the inventive punch would be suitable are disclosed in U.S. Pat. No. 4,574,669 and PCT Application PCT/US0304962.

In order to both support sheets as they pass through the rotary punch assembly and to facilitate punching the perforations through the sheets, a base or lower roller 24 is provided. In accordance with the invention, the lower roller 24 includes a resilient surface 26 such that as a sheet progresses through the nip 28 formed between the punch pin roller 12 and the lower roller 24, the punch pins 14 press against the sheet and the resilient surface 26 of the lower roller 24. The punch pins 14 will penetrate the sheet as the punch pins 14 depress the sheet against the resilient surface 26.

The currently preferred embodiment of the invention includes a rubber lower roller 24. It has been determined that rubber provides sufficient depressibility and resiliency to result in clean cuts through sheets passed through the nip 28, while providing a relatively durable lower roller 24. Other resilient materials may likewise be utilized in the lower roller 24. Moreover, the lower roller 24 may be formed essentially entirely of a resilient material such as rubber, or the roller may be formed of steel or the like and have a surface covering of a resilient material, such as rubber.

In accordance with an important aspect of the invention, preferably only the punch pin roller 12 is driven, while the lower roller 24 is freely rotating, that is, not driven. It will be appreciated that the roller may have some resistance to rotation as a result of, for example, friction resulting from the mounting arrangement. No complex gearing arrangements, however, are required in order to synchronize the rotation of the two rollers 12, 24. More importantly, however, the elimination of complex gearing arrangements utilized in synchronized rotary punch arrangements, facilitates greatly simplified and more rapid maintenance and changeover of the rotary punch 10. Additionally, the rollers 12, 14 themselves are of a relatively lower cost than traditional rotary punch arrangements. As a result, punch pin rollers 12 of various designs and configurations may be provided and an operator may readily change such a rotary punch assembly 10 to a new configuration for successive jobs.

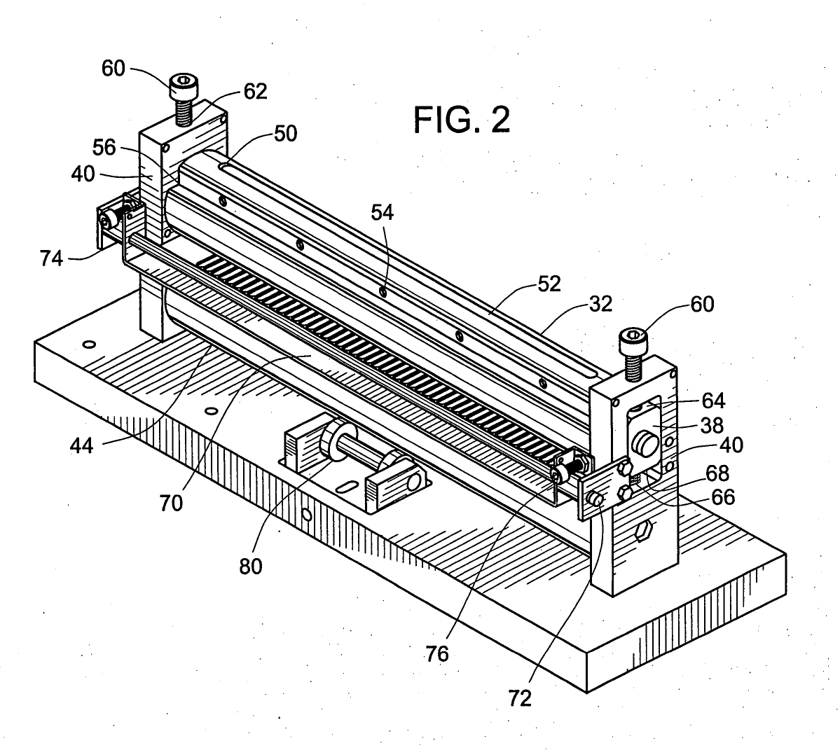

Referring now to FIG. 2, there is shown a second embodiment of the invention. In this embodiment, the cylindrical punch pin roller or pin holder 32 is similarly journaled in bearing supports 38 in roller supports 40 or the like, here shown extending from a base plate 42. In this embodiment, the punch pins (not visible in this view, but extending from the punch pin roller 32 in a manner similar to that shown in FIG. 1) are received in a longitudinally extending channel 50 in the roller 32. An elongated locking plate 52 is received in the channel 50 to bear against the heads of the pins to retain them in the proper position in the roller 32. The elongated locking plate 52, in turn, is retained in position in the roller 32 by screws 54 that bear against the side of locking plate 52. In order to prevent the screws 54 from interfering with proper rotation of the roller 32 and punching of sequential sheets, the screws 54 are received in an elongated channel 56 in the roller 32. It will be appreciated, however, that alternate manners of mounting the pins in the punch pin roller 32 may be provided, or the punch pin roller may be fabricated such that the pins may not be changed out individually, but, rather, are permanently secured to the punch pin roller.

In order to provide clean punching of the sheets passing between the rollers 32, 44, the optimal separation between the punch pin roller 32 and the lower roller 44 may be adjusted. This adjustment can be particularly important in view of the preferred, resilient material of the lower roller 44. In the embodiment illustrated in FIG. 2, the punch pin roller 32 is adjustable towards or away from the lower roller 44, although, in other envisioned embodiments of the invention, one or both of the rollers 32, 44 may be so adjusted. In this regard, roller tension screws 60 are received in threaded bores 62 in the roller supports 40. As the roller tension screws 60 are rotated inward, they bear against the surface 64 of the bearing supports 38 to adjust the separation of the rollers 32, 44. To bias the bearing supports 38 toward the roller tension screws 60 and the punch pin roller 32 away from the lower roller 44, biasing springs 66 are positioned to bear against the lower surface 68 of the bearing supports 38.

To assist in removal of the punch pins from the perforated sheet, a stripper plate 70 may be provided at the nip between the rollers 32, 44. In this embodiment, the stripper plate 70 is pivotably mounted to the roller supports 40 by a pivot shaft 72, the ends of which are received in brackets 74 mounted to the roller supports 40. The pivoted position of the stripper plate 70 may then be determined by stripper adjustment screws 76 which bear against a surface of the roller supports 40, the stripper plate 70 preferably being further biased into position by one or more springs (not visible). In this way, the position of the stripper plate 70 may be adjusted to account for variables such at the set separation of the rollers 32, 44, and the thickness of the sheets to be passed between the rollers 32, 44.

In order to further support the lower roller 44, particularly when the roller 44 is formed of an entirely resilient material, pairs of lower support rollers 80 are provided along the generally lower surface of the lower roller 44. One such pair of rollers 80 is shown in the illustrated embodiment. A further pair is preferably provided along the other side of the lower roller 44, extending upward from the base plate 42 such that the two pairs of rollers 80 cradle the lower roller 44. The rollers 80 are preferably freely rotating and disposed an adjustable distance from the lower roller 44.

In summary, the invention provides a rotary punch arrangement 10 that may be disposed in-line or as a standalone device. It is economical to both operate and maintain, and provides considerable advantages over conventional rotary punch arrangements. The rotary punch arrangement includes a first driven punch pin roller, and a second roller having a relatively softer surface for receiving the punch pins as they perforate the sheets passing between the two rollers. The second roller may be driven or, preferably, it may be freely rotating, eliminating the complexity of standard punch roller arrangements.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. A punching arrangement for perforating at least one sheet, the arrangement comprising
a driven, rotatably mounted punch pin roller comprising a peripheral surface and at least one punch pin protruding from said surface,
a base roller, said base roller having a resilient peripheral surface and being mounted for free rotation,
said punch pin roller and said base roller being disposed in a substantially parallel relationship such that the punch pin of the punch pin roller contacts the surface of the base roller as the punch pin roller rotates and no sheet is passed between the rollers, the punch pin sandwiching a portion of the sheet against the base roller as the sheet is passed between the rollers to perforate the sheet, contact of the punch pin with the base roller or with the sheet and the base roller during rotation of the punch pin roller imparting rotation to the base roller.

2. The punching arrangement of claim 1 wherein the base roller comprises a core and a resilient surface covering.

3. The punching arrangement of claim 2 wherein the core comprises steel.

4. The punching arrangement of claim 2 wherein the core comprises a polymeric material.

5. The punching arrangement of claim 1 wherein the surface of the base roller comprises an elastomeric material.

6. The punching arrangement of claim 1 wherein the surface of the base roller comprises rubber.

7. The punching arrangement of claim 1 wherein the punch pin roller comprises a first punch pin arrangement, and said punching arrangement further comprises a second punch pin roller having a second punch pin arrangement, said punch pin roller and said second punch pin roller being interchangeable in said punching arrangement.

8. The punching arrangement of claim 1 further comprising a drive mechanism for rotationally driving the punch pin roller.

9. The punching arrangement of claim 1 wherein one of the punch pin roller or the base roller may be removed from the punching arrangement and replaced without removing the other of the punch pin roller or the base roller.

10. The punching arrangement of claim 1 further comprising mounting structure rotatably mounting the base roller, the mounting structure causing some resistance to rotation of the base roller.

11. The punching arrangement of claim 1 wherein at least one of the punch pin roller or the base roller is adjustable to adjust a space formed between the punch pin roller and the base roller.

12. The punching arrangement of claim 1 further comprising a stripper disposed to assist in removal of the punch pins from perforations in the sheet.

13. The punching arrangement of claim 12 wherein the stripper is adjustably mounted whereby a distance between the base roller and the stripper may be adjusted.

14. The punching arrangement of claim 12 wherein the stripper is pivotably mounted.

15. In a machine for processing successive sheets of paper, a rotary punch having a first punch pin roller that is driven, and a second roller that comprises a resilient surface and is freely rotating, said rollers forming a nip therebetween for passage and perforation of the sheets.

16. The rotary punch of claim 15 wherein the resilient surface comprises an elastomeric material.

17. The rotary punch of claim 15 wherein the resilient surface comprises rubber.

18. The rotary punch of claim 15 wherein the second roller comprises a core comprises steel.

19. The rotary punch of claim 15 wherein the second roller comprises a core comprises a polymeric material.

20. The rotary punch of claim 15 further comprising mounting structure rotatably mounting the second roller, the mounting structure causing some resistance to rotation of the second roller.

21. The rotary punch of claim 15 wherein at least one of the punch pin roller or the base roller is adjustable to adjust a space formed between the punch pin roller and the base roller.

22. The rotary punch of claim 15 further comprising a stripper disposed to assist in removal of the punch pins from perforations in the sheet.

23. The rotary punch of claim 22 wherein the stripper is adjustably mounted whereby a distance between the base roller and the stripper may be adjusted.

24. The rotary punch of claim 22 wherein the stripper is pivotably mounted.
